(19) United States
(12) Patent Application Publication
(10) Pub. No.: US 2024/0217300 A1
(43) Pub. Date: Jul. 4, 2024

(54) SENSOR DEVICE

(71) Applicant: ZF CV Systems Europe BV, Brussels (BE)

(72) Inventors: Konrad Feyerabend, Hannover (DE); Stefan Filter, Hannover (DE); Oliver Kortmann, Ronnenberg (DE); Johann Lucas, Sehnde (DE); Oliver Topic, Hannover (DE)

(21) Appl. No.: 18/607,035

(22) Filed: Mar. 15, 2024

Related U.S. Application Data
(63) Continuation of application No. PCT/EP2022/075252, filed on Sep. 12, 2022.

(30) Foreign Application Priority Data
Sep. 17, 2021 (DE) 10 2021 124 079.4

(51) Int. Cl. B60G 17/019; B60G 17/0165

(52) U.S. Cl. CPC B60G 17/01908; B60G 17/0165; B60G 2300/02; B60G 2400/0516; B60G 2400/821

(57) ABSTRACT

Sensor device for determining the spatial position of the coachwork or body of a vehicle wherein inclinations or existing distances in each case relative to one another of the body or coachwork and axles or chassis and/or road surface are measurable via the sensor device and the signals from the sensor device corresponding to the determined inclinations or distances are transmittable to an electronic control device of a level-regulating system and are processable there in a regulating algorithm, wherein the sensor device has a combination of at least one distance-measuring sensor and an inclination sensor, and also an electronic evaluation unit, wherein the sensor signals from both sensors are processable by the electronic evaluation unit and are transmittable to the electronic control device.

### CROSS-REFERENCE TO RELATED APPLICATIONS

This application is a continuation application of international patent application PCT/EP2022/075252, filed Sep. 12, 2022, designating the United States and claiming priority from German application 10 2021 124 079.4, filed Sep. 17, 2021, and the entire content of both applications is incorporated herein by reference.

### BACKGROUND

The coachwork or body of a vehicle is also referred to as the vehicle chassis. The term “road surface” refers here to the road in general, that is, including, for example, unpaved roads or farm tracks. The term “spatial position” relates to the position of the chassis in the three-dimensional space, but, in particular, the height and the position of the chassis in relation to the other vehicle components, such as the axle or suspension.

Generic sensor devices are commonplace in electronic chassis controllers and supply the signals via which the height of the body or coachwork above the axle or above the road can be controlled and modified, that is, the signals which a level-regulating system requires so that the regulating algorithm stored there is even capable of functioning.

Relatively simple known sensors include mechanical height sensors, for example the frequently used rotary angle sensors, via which a suspension travel is converted via a lever mechanism into a rotational movement, whereby a change in height, for example, of a vehicle axle or chassis element, can be determined. The lever mechanism of such rotary angle sensors is clearly relatively susceptible to damage or contamination.

U.S. 2009/0021720 discloses a different type of height sensor. A sensor device is described there for measuring a suspension travel of wheels or axles of vehicles, in particular utility vehicles. In a level-regulating system for pneumatically sprung vehicles, it is provided that a beam of a radar signal or high-frequency signal is emitted by a sensor configured as a transceiver and is received once more following reflection on a reference or reference surface.

On one hand, the mechanically complex rotary angle sensors that are equipped with a lever system are therefore intended to be replaced and, on the other hand, the sensor signal is intended to be essentially unaffected by changes in temperature, changes in pressure and ambient conditions. The suspension travel and also the speed of the spring deflection can be determined by the sensor system provided there. However, the position of the vehicle chassis is difficult to determine via a sensor device of this type.

DE 10 2019 212 469 A1 discloses an air spring with bellows, in the internal volume of which a radar sensor (transceiver) is arranged which measures not only the distance between the sensor arranged on the cover plate of the air spring and the reflector element arranged on the baseplate of the air spring but also an inclination between the sensor and the reflector element. The measurement of the inclination is important there for compensating a deviation from an exactly perpendicular alignment of the sensor and the reflector element occurring due to material fatigue or vibrations. However, the inclination determined in this way provides no evidence with regard to the behavior or position of the coachwork or chassis and is less usable for controlling the vehicle.

In many applications in the field of level regulation of vehicles, conventional, simple solutions are further used on cost grounds, for example rotary angle sensors with which only a single element of height information relating to the entire vehicle can be determined via a sensor. Even if further, very high precision measuring sensors for height measurement are available in the prior art, such as, for example, Hall sensors or inductively measuring rotary angle sensors, the relevance and meaningfulness of such height measurements are clearly also dependent on an even load distribution, that is, on an assumed horizontal position of the chassis. If a valid assessment is also to be made here concerning the inclination of the body, for example, in relation to the road or to an axle, a plurality of height sensors/sensors on different vehicle corners or axles would be required. This in turn increases assembly cost, complexity and maintenance.

A range of sensors via which inclinations in relation to the vertical direction predefined by gravity can be measured also exist in the prior art. As a general rule, the change in position of measuring elements is measured electronically, inductively, capacitively or optically. Miniaturized sensors and sensors configured as MEMS (Micro-Electro-Mechanical System) sensors, for example piezoelectric sensors which are also used in mechanical engineering to control robots, are also known. High-resolution acceleration sensors, known as “low-g” acceleration sensors, or used as sensors to determine an inclination.

### SUMMARY

It is an object of the present disclosure to provide a robust and easily assembled sensor unit via which a measurement of distances and inclinations which is as unaffected as possible by ambient conditions can be performed within a level-regulating system, wherein the sensor unit requires little installation space, is simple to install, allows reliable measurements and can be integrated in a simple manner into a controller of a level-regulating system.

This object is, for example, achieved by a sensor device for determining a spatial position of a coachwork or body of a vehicle, wherein inclinations or existing distances in each case relative to one another of the body or coachwork and axles or chassis and/or road surface are measurable via the sensor device and signals from the sensor device corresponding to determined inclinations or distances are transmittable to an electronic control device of a level-regulating system and are processable there in a regulating algorithm. The sensor device includes: a combination of at least one distance-measuring sensor and an inclination sensor; and, an electronic evaluation unit configured to process signals from both the at least one distance-measuring sensor and the inclination sensor and transmit the signals from both the at least one distance-measuring sensor and the inclination sensor to the electronic control device.

The sensor device has a combination of at least one distance-measuring sensor and an inclination sensor, and also an electronic evaluation unit, wherein the sensor signals from both sensors are processable by the existing electronic evaluation unit, in particular by a microcontroller, and are transmittable to the electronic control device or to further electronic processing elements.

Such a combination of a distance-measuring sensor and an inclination sensor within a single sensor device, and the processing of the signals on both sides via a single electronic evaluation unit associated with the sensor unit produce a very compact device in which a plurality of sensors jointly and collaboratively generate a meaningful signal which allows not only the distance to a reference object but also the inclination of the reference object to be determined, or which allows the inclination of the object to which the sensor device is attached to be determined. As a result, a multiplicity of individual sensors and their respective individual electronic signal processing elements are dispensed with and the complexity of the overall system can therefore be reduced. A number of economic benefits are clearly also gained as a result, since a range of feed lines and devices used for mounting purposes and for setting up a diversity of sensors can be dispensed with.

In an embodiment, the distance-measuring sensor is configured as a radar sensor having an associated evaluation unit in the form of a microcontroller for processing the radar signal, and the evaluation unit of the radar sensor is also provided and configured/programmed to process the signals from the inclination sensor. Here, the term “radar sensor” obviously also includes sensors configured as transceivers.

In any event, the performance of the distance measurement via a radar signal or a high-frequency signal involves a downstream electronic system which is configured to determine the delay differences of the transmitted and reflected beam. If, via corresponding additional programming or additional functions, this downstream electronic system is enabled to process the signals from an inclination sensor also, for example signals from a sensor which implements the aforementioned measurement principles, this produces a highly compact and essentially simple sensor device which supplies a highly meaningful signal.

Furthermore, an inclination sensor which is configured in the form of a miniaturized MEMS can be integrated without difficulty into the structural unit of a radar sensor.

The sensitivity of a radar sensor of this type is perfectly suitable for measuring distance changes in the form of minute vibrations of the reference component.

In a further configuration, the inclination sensor is configured as an acceleration sensor via which not only the acceleration due to gravity but also other accelerations in space are measurable in a plurality of axes, as a result of which an existing inclination in space is then determinable. It is possible, for example, via an inclination sensor configured in this way, to measure whether the inclination of the reference object matches the determined accelerations, for example, currently prevailing centrifugal forces, braking forces and acceleration due to gravity.

Driving through a steep curve, for example, is conceivable, wherein the vehicle with a body inclined in the absolute coordinate system is also in a “correct” tilted position corresponding to this situation, that is, in relation to its axles and the centrifugal force generated by the speed of the curve. If this state were not identified and, for example, the measured absolute inclination of the coachwork of the vehicle in a steep curve also resulted in a standard response of the system which aimed to set the coachwork horizontally in space, this would create serious difficulties for loading and for passengers. Conversely, the same would apply if, in a curve driven through at speed, an adapted tilted position of the body is intended to be achieved in order to reduce the effect of centrifugal forces on passengers or load.

In a further configuration, the sensor device is arranged on the coachwork or body of the vehicle (vehicle chassis) in such a way that at least the distance from a vehicle axle to the body and the body inclination are measurable. Such an arrangement offers advantages, particularly in that a radar sensor arranged on the vehicle chassis with corresponding settings of the beam angle (beam lobe) and reflectors on the reference object is perfectly capable of also measuring the distance from objects not associated with the axle, that is, for example, the distance to the road level. The different delay times and the intensities of the beam reflected by the axle or road are determinable by the evaluation unit with corresponding reference values.

In a further, relatively easily implementable and therefore also advantageous configuration, the sensor device is arranged on an axle of the vehicle, in particular a motor vehicle, in particular a utility vehicle, in such a way that the distance from the vehicle axle to the body and the inclination of the axle are measurable.

A sensor device according to the disclosure can advantageously be provided within a level-regulating system of a vehicle, in particular a motor vehicle, in particular a utility vehicle. The precise signals from such a sensor device, which are highly meaningful following the electronic preprocessing by the evaluation unit, allow very precise level regulation that can also respond to inclinations of the chassis caused by incorrectly arranged load and to particular driving situations on an inclined surface. This is the case particularly in a further configuration of a level-regulating system of this type in which, in addition to the sensor device with a combined distance-measuring sensor and inclination sensor, at least one further inclination sensor is provided either on the body or on the vehicle axle.

The same applies to a further configuration of a level-regulating system of this type in which, in addition to the sensor device with a combined distance-measuring sensor and inclination sensor, at least one further inclination sensor is provided in or on a central electronic control device (CCU; central control unit), that is, for example, is mechanically connected to a CCU.

A level-regulating system having the sensor device according to the disclosure is particularly suitable for an electronically controlled air suspension system of a vehicle, in particular a motor vehicle, in particular a utility vehicle. Air-sprung trucks, including those with truck trailers or semitrailers, the trailers as such or buses having an electronically controlled air suspension or lift system represent particularly suitable applications here. Due to the increased safety requirements in heavy goods vehicle traffic and in passenger transport, precisely responding level regulation is important and can obviously be implemented only via a safe and comprehensive sensor system.

### BRIEF DESCRIPTION OF DRAWINGS

The invention will now be described with reference to the drawings wherein:

FIG. 1 shows, in its upper and lower part, in each case schematically, a truck with a body and one of its axles, the truck having a sensor device according to the disclosure;

FIG. 2 shows schematically, in its upper part, a truck having a sensor device according to the disclosure on the underside of the body, and schematically, in its lower part, a truck having a sensor device according to the disclosure on one axle, wherein both versions in each case have a further inclination sensor; and,

FIG. 3 shows schematically, in its upper part, a truck having a sensor device according to the disclosure on the underside of the body and a further inclination sensor on a central electronic control device of the truck or of the level-regulating system, and schematically, in its lower part, a truck having a sensor device according to the disclosure on one axle and similarly a further inclination sensor on a central electronic control device.

### DETAILED DESCRIPTION

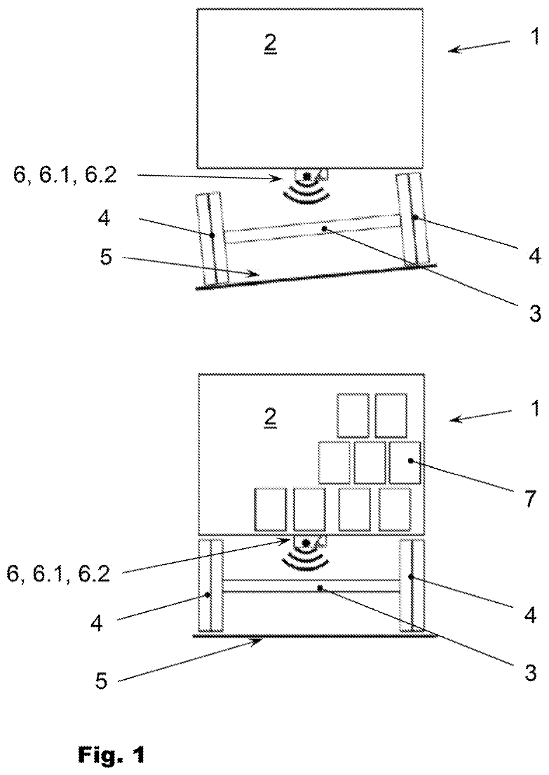

FIG. 1 shows schematically, and in the form of a diagram in the upper area, a truck 1 with a body 2 and also with one of its axles 3 with dual wheels 4. The truck 1 is air-sprung and is provided with a level-regulating system which has a sensor device 6 according to the disclosure. The air suspension and level regulation are not shown in detail here and in the other figures for the sake of clarity.

In the upper part of FIG. 1, the axle 3 is inclined obliquely in relation to the body 2 of the truck, since the truck with its wheels 4 is located on inclined road 5.

A sensor device 6 according to the disclosure is attached below the body and, along with a radar sensor 6.1 via which the distance from the vehicle axle 3 to the body 2 is measurable, also contains an inclination sensor 6.2 with which the body inclination as such is measurable. In this way, merely via a single sensor device 6 on the body, a situation of the vehicle is identifiable, the detection of which in a conventional manner would require the use of a plurality of sensors at different locations on the chassis or body.

In the upper part of FIG. 1, a situation is shown in which the truck 1 is located on an approximately horizontal road 5, but in which the load 7 inside the body is not correctly stacked, that is, is not arranged symmetrically to the vertical axis or horizontal axis of the truck 1 in a lateral direction. Even here, it is possible with only a single sensor device 6 according to the disclosure to identify possible swaying or inclination of the body due to asymmetrically stored load.

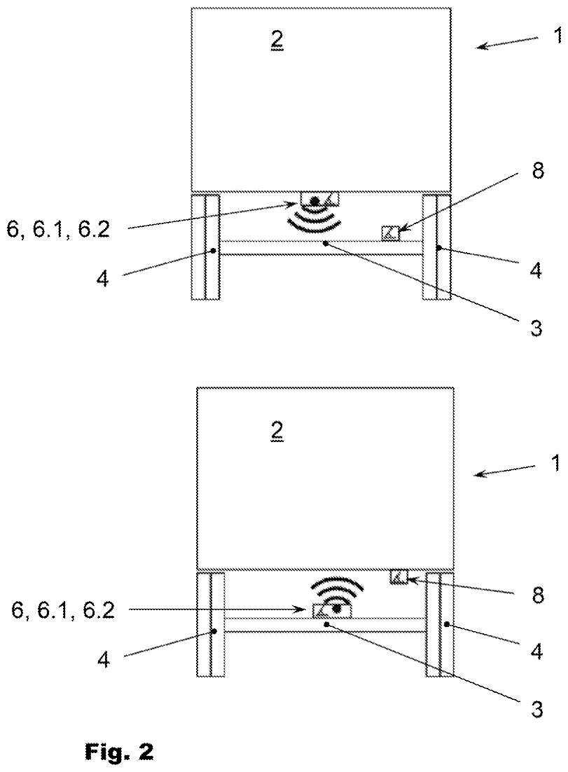

FIG. 2 shows in its upper part an embodiment in which a sensor device 6 according to the disclosure is arranged on the underside of the body 2 of an air-sprung truck 1 provided with a level-regulating system in such a way that the distance from a vehicle axis 3 to the body 2 and the body inclination are measurable. As already shown above, such an arrangement is also capable of measuring the distance from the body to the road. Adequate distance signals and inclination signals for the vehicle control or for controlling a level-regulating system are achieved here also via a minimum number of sensors. In addition to the sensor device 6 according to the disclosure with a combined distance-measuring sensor 6.1 and an inclination sensor 6.2, a further inclination sensor 8 is provided here on the vehicle axle 3.

The further embodiment shown in the lower part of FIG. 2 shows an air-sprung truck which is provided with a level-regulating system containing a sensor device 6 according to the disclosure which is arranged on an axle 3 of the truck and with which the distance from the vehicle axle 3 to the body 2 and the inclination of the axle 3 as such are measurable. In addition to the sensor device 6 according to the disclosure with a combined distance-measuring sensor 6.1 and an inclination sensor 6.2, a further inclination sensor 8 is provided here also, but on the body 2.

Both arrangements offer advantages. With an additional inclination sensor on the axle, the inclination of the road can easily be detected, whereas, with an inclination sensor on the body or chassis, a further input variable with which regulation can be simplified can be obtained for the control device, thus enabling the body or the loading surface to be aligned with the road inclination.

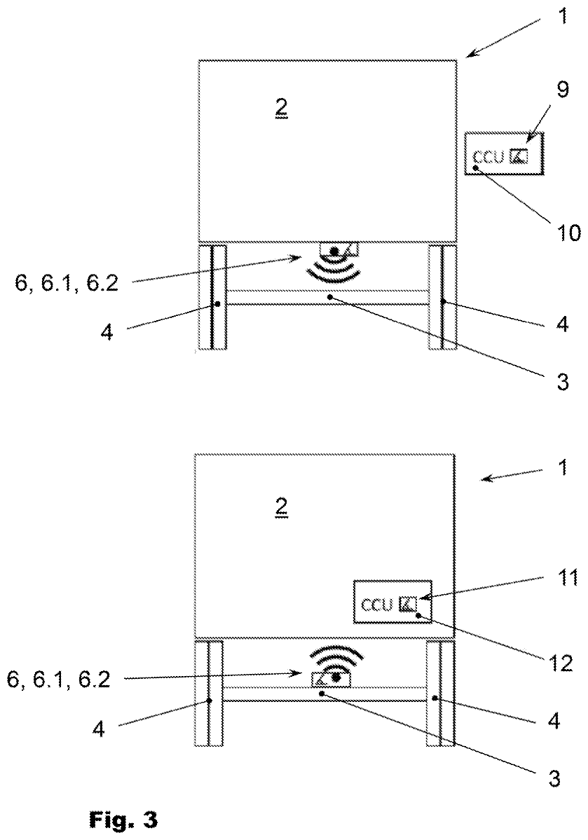

FIG. 3 shows in its upper part an embodiment in which a sensor device 6 according to the disclosure is arranged on the underside of the body 2 of an air-sprung truck 1 which is provided with a level-regulating system such that the distance from a vehicle axis 3 to the body 2 and the body inclination are measurable. In addition to the sensor device 6 according to the disclosure with a combined distance-measuring sensor 6.1 and an inclination sensor 6.2, a further inclination sensor 9 is provided on an electronic control device 10 of the truck/vehicle or of the level-regulating system. In this embodiment, the further inclination sensor 9 is connected to a CCU of the truck/vehicle or of the level-regulating system, via which signals can be captured and compared. This separate inclination sensor 9 detects the inclination actually present on the chassis.

The lower part of FIG. 3 shows a similar embodiment, but with a sensor device 6 according to the disclosure on an axle 3 of the truck and a further inclination sensor 11 on a CCU or central electronic control device 12 of the vehicle or of the level-regulating system, wherein the control device 12 is permanently connected to a component which in turn is connected to the axle. In this embodiment also, the further inclination sensor 11 is connected to a CCU of the truck/vehicle or of the level-regulating system. This offers similar advantages to those already outlined above with reference to FIG. 2. In addition, a further sensor housing is not required.

If a truck/trailer combination, for example, a traction unit with a semitrailer, is considered in this respect, the CCU can be fitted, for example, on the front part of the truck/trailer combination. Here, many traction units still have springs which only conditionally permit an inclination in relation to the axle. Information relating to the position/inclination of the road would therefore then also be obtained via a sensor arranged in this way. The arrangements shown in FIG. 3 therefore take into account these different applications.

It is understood that the foregoing description is that of the preferred embodiments of the invention and that various changes and modifications may be made thereto without departing from the spirit and scope of the invention as defined in the appended claims.

### REFERENCE SIGN LIST (PART OF THE DESCRIPTION)

1 Truck
2 Body of the truck
3 Axle of the truck
4 Wheels, dual wheels
5 Road/road surface
6 Sensor device
6.1 Distance-measuring sensor/radar sensor in the sensor device
6.2 Inclination sensor in the sensor device
7 Load
8 Inclination sensor
9 Inclination sensor
10 Control device (CCU)
11 Inclination sensor
12 Control device (CCU)

1. A sensor device for determining a spatial position of a coachwork or body of a vehicle, wherein inclinations or existing distances in each case relative to one another of the
body or coachwork and
axles or chassis and/or
road surface
are measurable via the sensor device and signals from the sensor device corresponding to determined inclinations or distances are transmittable to an electronic control device of a level-regulating system and are processable there in a regulating algorithm, the sensor device comprising:
a combination of at least one distance-measuring sensor and an inclination sensor; and,
an electronic evaluation unit configured to process signals from both said at least one distance-measuring sensor and said inclination sensor and transmit the signals from both said at least one distance-measuring sensor and said inclination sensor to the electronic control device.

2. The sensor device of claim 1, wherein said electronic evaluation unit is a microcontroller.

3. The sensor device of claim 1, wherein said at least one distance-measuring sensor is a radar sensor having a radar sensor evaluation unit in a form of a microcontroller for processing radar signals, and said radar sensor evaluation unit is also provided and configurable/programmable to process the signals from said inclination sensor.

4. The sensor device of claim 1, in which said inclination sensor is an acceleration sensor via which an existing inclination in space is measurable.

5. The sensor device of claim 1, in which said inclination sensor is an acceleration sensor via which an existing inclination in a plurality of axes is measurable.

6. The sensor device of claim 1, wherein the sensor device is arranged on the coachwork or body of the vehicle such that at least a distance from a vehicle axle to the body and a body inclination are measurable.

7. The sensor device of claim 1, wherein the sensor device is arranged on one of the axles of the vehicle such that a distance from the vehicle axle to the body and an inclination of the axle are measurable.

8. The sensor device of claim 1, wherein the vehicle is a motor vehicle.

9. A level-regulating device of a vehicle, the level-regulating device comprising:
a sensor device for determining a spatial position of a coachwork or body of a vehicle, wherein inclinations or existing distances in each case relative to one another of the
body or coachwork and
axles or chassis and/or
road surface
are measurable via the sensor device and signals from the sensor device corresponding to determined inclinations or distances are transmittable to an electronic control device of a level-regulating system and are processable there in a regulating algorithm;
said sensor device including a combination of at least one distance-measuring sensor and an inclination sensor; and,
said sensor device further including an electronic evaluation unit configured to process signals from both said at least one distance-measuring sensor and said inclination sensor and transmit the signals from both said at least one distance-measuring sensor and said inclination sensor to the electronic control device.

10. The level-regulating device of claim 9 further comprising at least one further inclination sensor provided on either the body or one of the vehicle axles.

11. The level-regulating device of claim 9 further comprising at least one further inclination sensor provided in or on a central electronic control device.

12. The level-regulating device of claim 9, wherein the vehicle is a motor vehicle.

13. An electronically controlled air suspension system of a vehicle comprising the level-regulating system of claim 9.

14. The electronically controlled air suspension system of claim 13, wherein the vehicle is a motor vehicle.

15. An air-sprung truck or bus comprising the electronically controlled air suspension system according to claim 13.
